(19) United States
(12) Patent Application Publication
(10) Pub. No.: US 2008/0294994 A1
(43) Pub. Date: Nov. 27, 2008

(54) Event management system and method with calendar interface

(76) Inventors: Justin David Kruger, Milwaukee, WI (US); Jon Gunther Thoms, Brookfield, WI (US); Dennis Tabieros, Cudahy, WI (US)

Correspondence Address: Justin Kruger, 1122A North Cass Street, Milwaukee, WI, 53202, US

(21) Appl. No.: 12/152,818

(22) Filed: May 16, 2008

Related U.S. Application Data
(60) Provisional application No. 60/930,807, filed on May 18, 2007.

(51) Int. Cl. G06F 3/048; G06F 17/30

(52) U.S. Cl. 715/733; 715/781; 707/104.1; 707/E17.044

(57) ABSTRACT

A system and method for managing, advertising, and promoting events. Event information is collected from users and the Internet and stored in one or more databases on one or more servers. The event information is organized in the one or more databases according to various attributes and may be selectively displayed on one or more styles of calendar display interfaces, which may be in the form of a web page. The system monitors user interaction with the calendar display interfaces to charge and credit event advertisers, event promoters, and managers of event calendars.

### CROSS REFERENCE TO RELATED APPLICATION

This application claims priority to United States Provisional Patent Application No. 60/930,807, filed May 18, 2007, the entire contents of which are hereby incorporated by reference herein.

### BACKGROUND OF THE INVENTION

Events are traditionally defined using space and time-based parameters. Events are often associated with at least a location, a date, a time, and a duration. In some cases, events may also be associated with individuals (e.g., a birthday) or groups of individuals (e.g., a board meeting). To keep track of the events in people's lives, various calendar formats have been developed, including calendars that display entire months with individual cells representing the days of the month. Other calendars break the days down into individual hours or portions of hours, and are therefore able to accommodate additional events. Various forms of these calendars are available in both hard-copy (e.g. booklet-style weekly planners) and electronic form (e.g., the Microsoft® Office Outlook® calendar application) to help people manage and record events they have attended or plan to attend.

Event promotion, the general task of informing people of an upcoming event in the hopes that they will attend, has traditionally been accomplished using a number methods. Hard copy or electronic invitations are extremely common, and require the promoter to develop or purchase lists of potential attendees. These lists can be extremely long to develop and are often poorly targeted, resulting in a low occurrence of attendee acceptance. Event promotion can also be accomplished using traditional advertising. Rather than sending unique invitations to potential attendees, an event may be advertised generally using various media, such as magazines, radio, television, and the like. Perhaps the simplest and in some cases most effective method of traditional event promotion is word of mouth, where individuals who are aware of the event tell others who they think may be interested in either joining them at the event or attending the event themselves.

To generate revenue, a substantial number of Internet web sites post advertisements in various portions of their web pages. These ads are often referred to generically as banner ads because when such ads first became popular they appeared primarily at the top of a web page, extending banner-like from one side of the screen to the other. Currently, web designers are able to place ads in substantially any desired location on a given web page.

To facilitate the use of a single web ad on multiple web pages, standard sizes (generally designated by pixel height and width) for web ads were developed. In this way, one ad could be developed and the advertiser could then provide the ad to multiple web page designers who could easily insert the ad into their web pages.

Web-based advertising has also advanced to the point where ads can be selectively placed on a web site based upon a wide variety of criteria. For example, if an individual performs a web-based search using a search engine for “American automobiles,” the designers of the search engine web page, in connection with the advertisers who pay to have their ads displayed, may configure the web page to display advertisements from one or more American automotive manufacturers. Customizing the content of the web advertising space in this manner allows web page designers to sell what is essentially the same ad space to multiple advertisers, and allows advertisers to more precisely target their advertising to likely customers. Similarly, web retailers, such as Amazon.com, may also sell advertising space in which specific ads are displayed based upon what types of goods or services a specific individual may be seeking to purchase, or based upon the types of goods or services a known specific user (e.g. one with unique username which allows the website to store information related to that specific user) has purchased previously.

Another Internet-based development is the substantial increase in popularity of so-called “Social Networking” web sites. Examples of such sites include Myspace.com, Match.com, Friendster.com, Facebook.com and other web sites which allow users to create a personalized web page that includes user-defined information. Some sites, such as Myspace.com, allow users to almost fully customize their web pages, even allowing users to embed their own videos from sites such as Youtube.com in their personal page. Oftentimes the web site will still reserve certain portions of personal pages for the placement of advertisements.

### SUMMARY OF THE INVENTION

In some embodiments, the invention provides an event planning application that extracts web information from a plurality of websites, compiles the web information in a database, compares the web information in the database with user information provided by a user, which may include user information or web information located in other databases, and automatically updates one or more calendar applications associated with the user.

In other embodiments, the invention provides a calendar-based web advertisement including an advertisement application configured for placement on a web page. The application includes a calendar display portion which displays a specified period of time (e.g. a day, a week, or a month), and an event display portion which displays selected events which occur during or on a selected portion of the specified period of time (e.g. hours of a day, days of a week, weeks of a month, etc.). The selected events are provided to the application by an event database. The event database is created by receiving user-provided information including events entered by a user, and organizer-provided information including events provided by or collected from event organizers such as event venues, event promoters, event sponsors, and the like. The application is configured to display the events entered by the user and selected ones of the events provided by event organizers, the selected ones of the events provided by event organizers being selected based upon one or more known preferences, tendencies, or prior actions of the user.

In other embodiments, the invention provides a zoomable calendar interface that charges event promoters and advertisers in response to zooming of the calendar interface to a specific level of detail relative to one or more event listings.

### BRIEF DESCRIPTION OF THE DRAWINGS

FIG. 1 is a schematic illustration showing levels of service provided by, sources of information for, and recipients of information from, the present invention.

FIG. 2 is a schematic illustration of the event management application portion of the schematic of FIG. 1.

FIG. 3 is an illustration of one type of calendar application supported by the event management application illustrated in FIG. 2, and provided to the recipients of information illustrated in FIG. 1.

FIG. 4 is a schematic illustration showing levels of service provided by, sources of information for, recipients of information from, and types of information provided by, the present invention.

FIG. 5 is an illustration of a user interface provided by another calendar application that may be supported by the event management application illustrated in FIG. 2, and displaying a time period of approximately one month.

FIG. 6 is an illustration of the user interface of FIG. 5 displaying a time period of approximately two days.

FIG. 7 is an illustration of the user interface of FIG. 5 displaying an example of a possible event entry for one of the days from the two day time period of FIG. 6.

FIG. 8 is an illustration of the user interface of FIG. 5 displaying a time period of approximately one decade.

FIG. 9 is an illustration of the user interface of FIG. 5 displaying a time period of approximately one century.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. Also, electronic communications and notifications may be performed using any known means including direct connections, wireless connections, etc.

In particular, it should be understood that some embodiments of the invention are implemented using various hardware and/or software based computing devices, such as personal or home computers, servers, mobile phones, mobile devices, and other devices that have processors or that are capable of executing applications or sets of instructions. In general, some embodiments may be implemented using existing hardware or hardware that could be readily created by those of ordinary skill in the art. Thus, the architecture of exemplary devices will not be explained in detail, except to note that the devices will generally have a processor, memory (of some kind), and input and/or output mechanisms. In some cases, the devices may also have one or more operating systems and one or more applications that are managed by the operating systems.

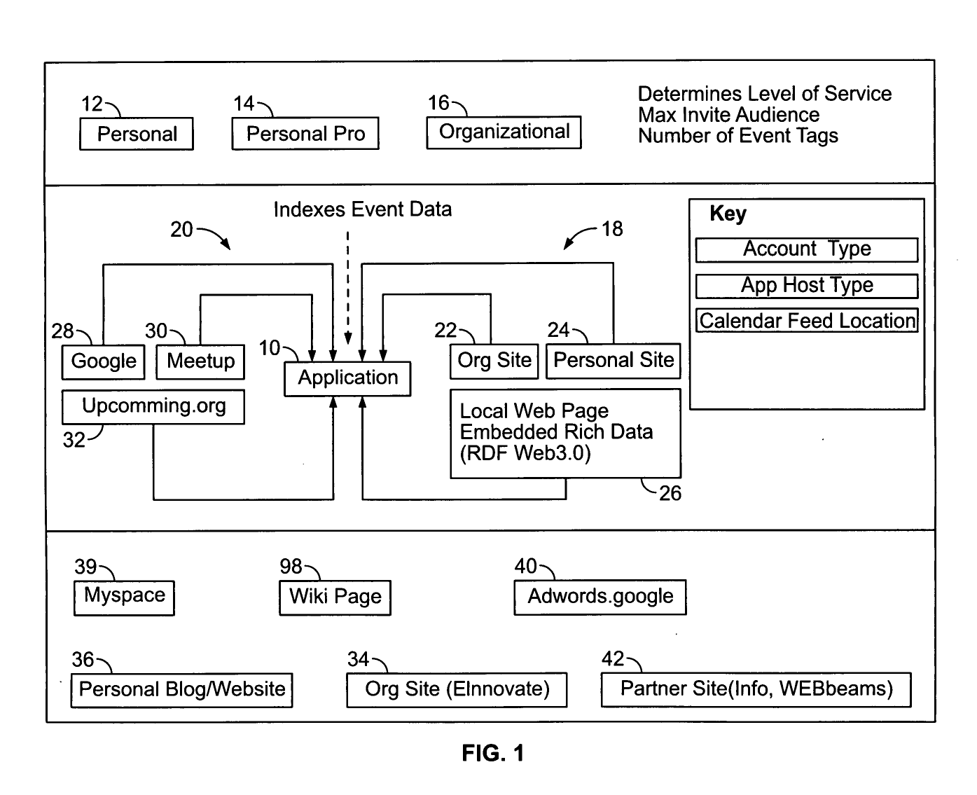

FIG. 1 is a schematic illustration of an event organization system including an event management application 10 embodying the invention. As discussed in further detail below, in some embodiments the event management application 10 includes, among other things, machine executable code and a database stored on one or more central servers. The code and the database send and receive information to/from remote terminals, such as servers, personal computers, and/or personal digital devices, generally over the Internet. In this regard, communications relating to the event management application 10 may be wired, wireless, or a combination thereof. In other embodiments, the event management application 10 resides locally in the memory of a single computer or personal digital device, but may still communicate over the Internet to send and receive information from external applications, websites, or substantially any other information sources available over the Internet.

Some portions of the event management application 10 also utilize a suitable display device (not shown), such as the monitor of a computer, or the display screen of a personal digital device (e.g. a cell phone). Some portions of the event management application 10 also utilize an input device that, like the display device, is generally associated with the computer or personal digital device. Examples of suitable input devices include, without limitation, any type of mouse device, such as a mouse, trackball, touchpad, or joystick, a stylus device, such as those often found on personal digital devices, or a touch screen device, in which case the display device and the input device are substantially one and the same. The vast array of suitable input devices available for use with computers and personal digital devices are generally well known to those skilled in the art. As such, the foregoing list is not intended to be exhaustive.

Event Management

The application 10 incorporates information provided by and obtained through observation of users with information provided by and obtained from external sources via the Internet to coordinate future events in the life of a user with future events in the real world or with future events of other users. Application 10 is also able to provide a customized summary of the coordinated future events, often in the form of a calendar, to third party web sites for display on those web sites in a manner determined by the user.

Application 10 is capable of supporting a variety of account types. Examples of such account types include personal 12, personal pro 14, and organization 16. Other account types may also be developed or supported as necessary. As discussed further below, each account type is able to access a specific set of features or options within Application 10, and certain accounts may require the user to pay a fee based in part upon the set of features or options associated with their account type. For example, personal accounts may be provided free of charge, however the set of features or options available to a personal account user may be relatively limited personal pro accounts may require a fee, but by paying the fee, personal pro users will have access to additional features or options. Organizational accounts may also require a fee, which may be significantly more than a personal account, however the features or options available to an organization account user will likely be greater in number and versatility than those provided to personal account users. As used herein, “users” may refer to an individual, a group or groups of individuals, or any type of business or corporate entity. Furthermore, an individual user account may itself include sub-user accounts, so that multiple sub-users are able to access the features available to, for example, a single organization user.

Application 10 communicates via the Internet or via other communication pathways, including dedicated communication pathways, with web pages or data-driven applications of users (“external user information” 18) and with web pages or data-driven applications of third parties (“external third party information” 20). Examples of external user information 18 include an organization's own web site 22, an individual's personal web site 24, or a local web page with embedded rich data 26. Application 10 may also receive external user information 18 from software applications capable of uploading data to the Internet. One example of such software is Microsoft Outlook, which includes a calendar application that supports the uploading of information from the calendar to the Internet. Dedicated plugins to existing software may also provide an interface to the Application 10.

Examples of external third party information 20 include information gathered from third party websites that are freely accessible to the public, such as google.com 28, meetup.com 30, or Upcomming.org 32. These websites, as well as others not discussed herein, include calendar applications which are capable of storing personal or public event information. Other websites, such as movies.aol.com include event times (e.g. movie showings) and event locations (e.g. movie theaters) which can be extracted from the web pages and imported into Application 10. Similar web pages exist for concert venues (e.g. ticketmaster.com), conference centers, government agencies, and the like. While some of the information from these websites may be freely accessible to the public, as discussed below, in some cases partnerships may be developed with such websites in order to fully promote events to a user.

Application 10 collects the external user information 18 and the external third party information 20 and indexes the information in a database. To the extent possible, each event is stored in the database along with information relating to the time, date and location of the event. The event may include events in the life of the user, such as a meeting with a friend at a restaurant, or events being hosted, held, or otherwise promoted by third parties, such as a movie showing or concert.

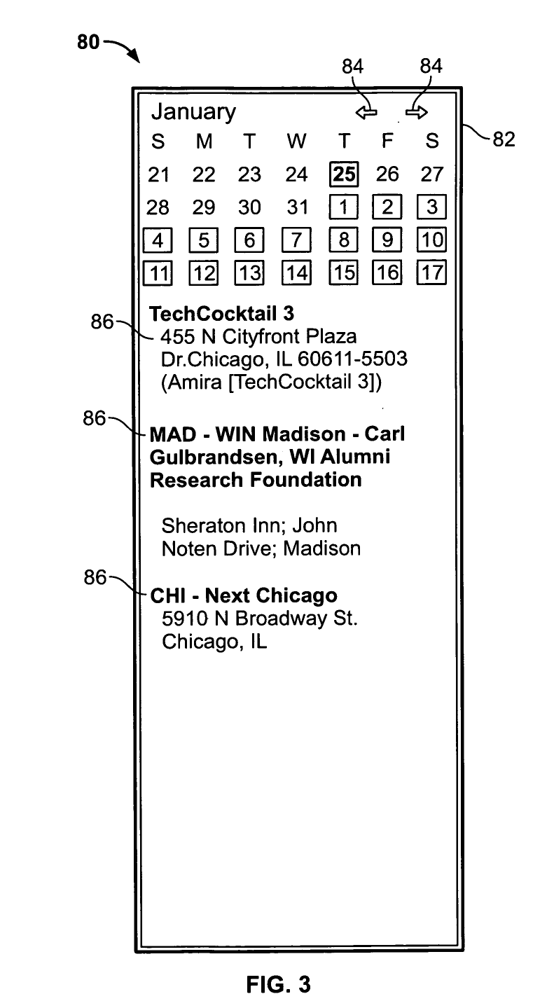

Once the database has been compiled, selected information from the database is provided to other web pages in a specified format. Of course the format by which the information is provided will vary depending on a particular web page. Some of the web pages to which information is provided may be the same as the web pages from which external user information 18 and external third party information 20 was originally received. For example, the selected information may be provided to an organizations web site 34 or a personal blog or personal website 36, often in the form of a calendar application. Information may also be provided to third party websites, such as myspace.com 39. With respect to myspace.com, or other sites similar to myspace.com, a user might customize his or her myspace page in such a way that, when another web user views the user's myspace page, a calendar application is displayed showing upcoming events in the life of the user. Furthermore, where the person viewing the user's myspace page (or any other web page including the application) and the viewer is also a user of the application 10, the Application 10 may be configured to merge the calendars of the person viewing the web page and the web page user. In many cases this can be accomplished by providing the viewing party with a cookie such that, when the viewer views the web page, the application 10 recognizes that the viewer is also a user of the application and merges the viewer's events with the events of the webpage. This allows web page viewers to quickly and easily determine whether and how the events posted by the web page fit into the events of his or her life. Examples of calendar applications capable of operating in this manner are discussed further below and illustrated in FIGS. 3 and 5-9.

Application 10 may also provide selected information to google sites 40, or other websites 42 that are partnered with Application 10 for the purpose of promoting and organizing events and activities. For example, Application 10 may provide a list of events based upon semantic information provided by other ad networks, in some cases in exchange for a suitable service fee. Website publishers may also be charged for use of the application on the basis of a set cost per 1000 (“cpm”) website loads of the application. Furthermore, advertisers seeking to advertise other services or products may be charged to search the event database for events or event listings that might provide a suitable target audience for the advertiser's products or services.

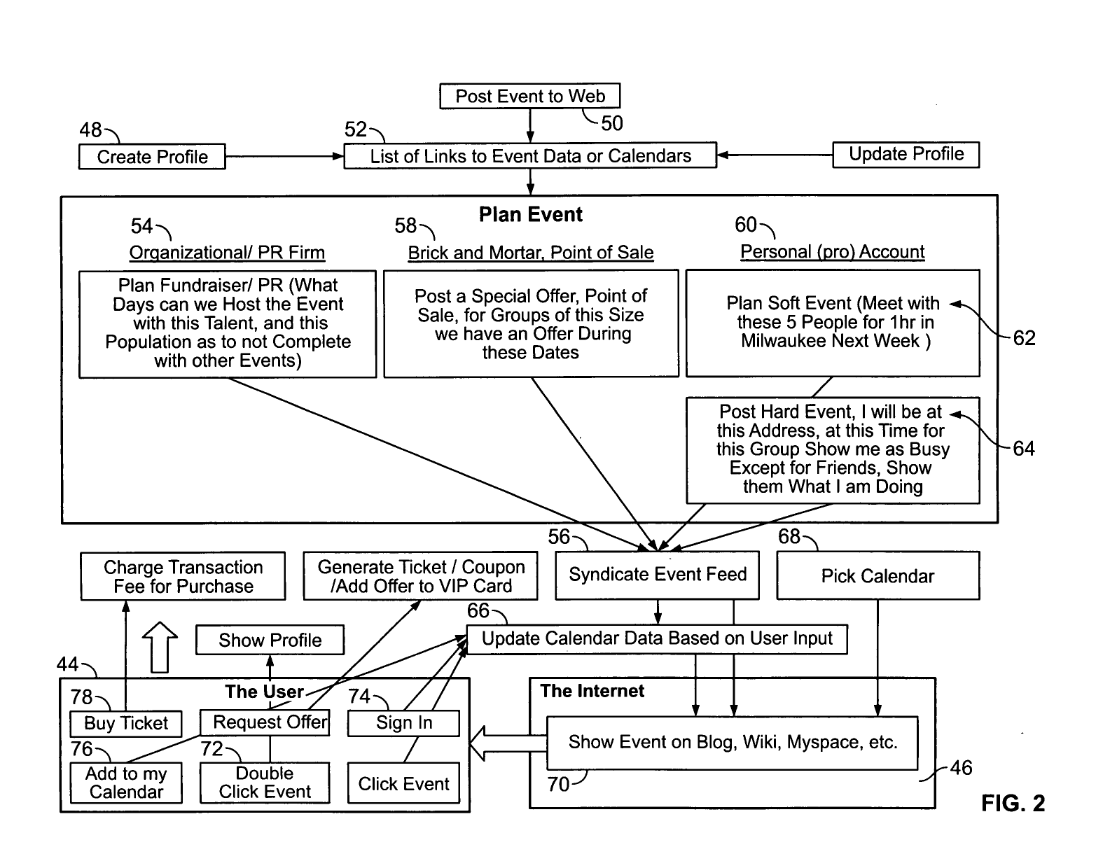

FIG. 2 is a schematic representation of how application 10 interacts with individual users 44 and the Internet 46 to plan, schedule, coordinate, and promote events. Much like individual users, an individual event is provided with its own event profile. An event profile can be created 48 by individual users, by organizational users, or may be automatically created by application 10 in response to acquiring information about a specific event from the Internet when the event is posted to the web 50 using, for example, web page crawlers or data mining applications. The event profile includes, among other things, a list of links to event data or event calendars 52. The links may be to other locations on the Internet, or may be to other web pages within the application web site. As the event moves from initial conception, through the planning and scheduling process to the actual execution of the event, the event profile is consistently updated to reflect, among other things, the event date, time, location, and attendees. In some embodiments, the event profile may remain active after the execution of the event so that feedback about the event can be posted to the event profile by attendees. The feedback and the entire event profile may include text, images and/or substantially any form of multimedia information such as photos, video, audio, and the like, without limitation.

While other types of event organizers are possible, FIG. 2 illustrates three possible types of users that might organize an event. An organizational or public relations firm 54 might use application 10 to research when a certain type of event would be feasible. For example, the organizational or public relations firm could use application 10 to see when certain types of entertainers are available to form, and when certain venues are available for performances. The firms might also search application to determine when a large number of individuals within a certain target demographic have no scheduled plans/events. After reviewing all of this information, the firm would be able to coordinate planning of the event with the entertainer and the venue, and then send targeted event invites to the individuals within the target demographic group by way of the syndicate event feed 56, discussed further below.

A brick and mortar or point of sale business 58, such as, for example, a retail store, could also plan/organize a special offer or sale using various features of application 10. For example, the retail store could create and post an event promoting a special sale on certain items. The sale could have a fixed price or could include a particular set of requirements in order for a sale price to be available. For example, if a group of five people show up for the sale event, each of them might receive 10% off his/her purchase. A group of ten people may each be given a discount of 20%, and so on. The dates, times, and terms of the sale offer or retail event would all be created and stored within the application event profile, and posted to the syndicate event feed 56.

An individual, such as a user with a personal pro account 60 may also create an event profile. As illustrated, the personal pro account 60 includes two levels of planning, a “soft event” 62 and a “hard event” 64. While the soft and hard events 62, 64 are illustrated and described with respect to the personal pro account 60, it should be appreciated that the soft and hard event features might also be utilized by other type of event organizers, such as the organizational or public relations firm 54 or the point of sale business 58. For a soft event 62, the user may indicate that he/she wants to meet with a certain group of people, for a certain length of time, within a certain geographical area. Upon posting the soft event 62 to the syndicate event feed 56, application 10 would operate to contact the individuals the original user wanted to meet with. These individuals could then utilize the calendar and other functions of application to determine a suitable specific time, and a suitable specific location for their meeting. Voting may also be a part of the soft event planning process, and may be communicated to the application 10 by way of text messages, emails, or other forms of electronic communication. Once the event plans were sufficiently well defined, the soft event 62 could be changed to a hard event 64 and the specific time, location, and attendees of the event would be included in the event profile. The specifics of the hard event 64 could then be displayed on each of the attendees' individual calendars and, depending on the attendees' individual settings, that time could be displayed as busy or the event details might be shown. Whether the time is shown as busy or whether the event details are shown on the individual attendee's calendar may depend on, among other things, who is viewing the individual attendee's calendar.

The syndicate event feed 56 operates to organize and categorize all the calendar data that is generated by the event planners and place it on one or more master calendar databases 66. The data in the master calendar database 66 is updated continuously in response to, among other things, creation of a new event, the indication by attendees that they will or will not be attending an event, and the changing of an event from a soft event 62 to a hard event 64. Event information from the syndicate event feed 56 is posted to the Internet directly or through the master calendar databases 66. Depending on what type of web site the event is being posted to, the syndicate event feed 56 may send date, time, location and/or attendee information to the Internet website. In preferred embodiments, each website that receives information from the syndicate event feed 56 is capable of running a flash application (discussed below) such that the data provided by the syndicate event feed 56 can be provided to the flash application in a specific format for display on the specific website in a specific way. For example, as discussed further below, different formats of calendars can be selected (box 68, FIG. 2) for display on different websites and for use by different types of users. While the use of a flash application is specifically discussed herein, it should be appreciated that other “rich internet applications” such as silverlight, moonlight, java, javascript, etc., may also be used as a foundation for the calendar applications. Examples of locations on the Internet 46 where a user might display a calendar include personal blogs, group wiki pages, an individual or organizational myspace page, or an organization or personal website (box 70, FIG. 2).

Once the event information is posted to the Internet 46, it is available for viewing and interaction by other users 44. The other users 44 may or may not already be users of application 10. If a user 44 sees an event in which he/she is interested posted on a calendar on the internet, the user 44, in accordance with standard web browsing behavior, will click or double-click on the event 72. After the user 44 clicks the event, application 10 will react in different ways depending on the nature of the event and the nature of the user. For example, if the event is a private event and the user 44 is a application 10 user but is not currently signed in, the user 44 may be prompted to sign in 74 before viewing the event profile. Even if the user does sign in, if the user 44 is not a member of a certain group or network of groups that the group organizer may or may not have designated, the user may not be allowed to view some or all of the event information. If the user 44 is not an application 10 user, the user 44 may be prompted to open an application account. Part of the account opening process may include selection of certain interests and, depending on the answers to those questions and event characteristics determined by the event coordinator, the new user may or may not be allowed to view some or all of the event details. Furthermore, application 10 may record every time a certain event is clicked or double-clicked, regardless of any subsequent action taken by the user, to track general interest in the event itself, or to track the effectiveness of certain calendar formats or event display formats. If an event listing is sponsored or paid for by a specific party, that party may be charged each time a user clicks, double-clicks, or otherwise meaningfully interacts with the event listing.

Other types of events, referred to herein as “public events” may be completely visible to anyone on the Internet. In this case, any user 44 may be given full access to the complete event profile including the time, date, location, attendees, and the identity of the group organizer. Of course, the event organizer, when creating the event profile, can choose to reveal as much or as little about the event to various different types of users in any way the organizer desires.

In addition to merely acquiring information about an event, users 44 may also add the event to their individual calendars 76. The individual calendars 76 are preferably the individual calendars of application users, however, the system may be configured to automatically update other types of calendars such as google calendars or yahoo calendars located on the Internet, or Outlook calendars operating as software on an individual user's computer. In some embodiments, users may also be able to add events to their personal calendars by sending a text message or email from a mobile device. Specifically traditional media event advertising (e.g. print, radio, television, etc.) may include an event “short code” in the form of an alpha numeric code that can be sent to the application 10 as an email or text message. In response to receipt of the alpha numeric short code, the application 10 will automatically add the corresponding event to the user's calendar. The email address or telephone number form which the short code is sent can be used to identify the user without requiring additional identity verification procedures such as passwords or dedicated electronic security certificates.

A user 44 may also interact with the calendar and the event profile to purchase event tickets 78, or to print an entry coupon or VIP card. Whether or not a user 44 is provided with the opportunity to purchase a ticket, print an entry coupon, or gain access to a VIP card may depend on, among other things, whether the user 44 is known to the event organizer, or whether the user 44 is a known member of a specific group that the event organizer has designated as invitees or as having VIP status. Alternatively, a user who is not already a member of a selected group, or is not already known by the event organizer may submit a request to the group organizer for access, VIP or otherwise, to the event.

As each user 44 interacts with the calendar, the master calendar database or databases 66 are updated accordingly. In this way, attendees or groups of attendees and their status as attending, maybe attending, and not attending can be tracked and monitored by the event organizer. As information related to the event changes, such as the number of attendees, the information relating to the event that is displayed on the Internet 46 is also updated or displayed differently. Furthermore, once a user 44 has indicated his/her intent to attend an event, he/she may elect to be informed as other users or other groups of users similarly indicate their intention to attend or not attend the event.

Banner Calendar Interface

FIG. 3 illustrates one type of calendar display application 80 that can be displayed on various web pages on the Internet 46. The illustrated display application 80 is in the form of a tall banner and is sized to correspond to a commonly utilized size of web advertisements. These types of banners are generally positioned along the right or left hand edges of a web page. The display application 80 includes a calendar 82 which displays approximately a one-month period of time. The application 80 can also be configured to display a week, day, year, or any other length of time, as desired. A user 44 may interact with the calendar 82 by clicking on specific days or by using the arrow buttons 84 to scroll to different weeks, months, or days. In the illustrated example, the date January 25 has been highlighted by a user. Upon highlighting January 25, several events 86 that are scheduled to take place, or that are potentially taking place on January 25 are displayed. Which events 86 are displayed, the order in which they are displayed, and the amount of information relating to the date that is displayed can depend on, among other things, settings chosen by the event organizer when creating the event profile, and the type of user 44 that is viewing the calendar display application 80.

In some embodiments of the invention, the calendar display application 80 itself functions as a web-based revenue-generating advertisement. For example, event organizers seeking to promote their events can pay additional fees to application 10 in order to have their events displayed at the top of any given day, or to have their events displayed in a more prominent font or in a specific way. Other features that may require payment of additional fees including having an icon placed on a specific date, the icon being associated with the promoter, or otherwise indicating to a user 44 that an event is scheduled for that day, thereby making the user 44 more likely to click that particular day to see what events are scheduled. Upon clicking on an event, the user 44 can interact with the event as discussed above with respect to FIG. 2, including adding the event to his/her own calendar, or buying tickets to the event, among other things.

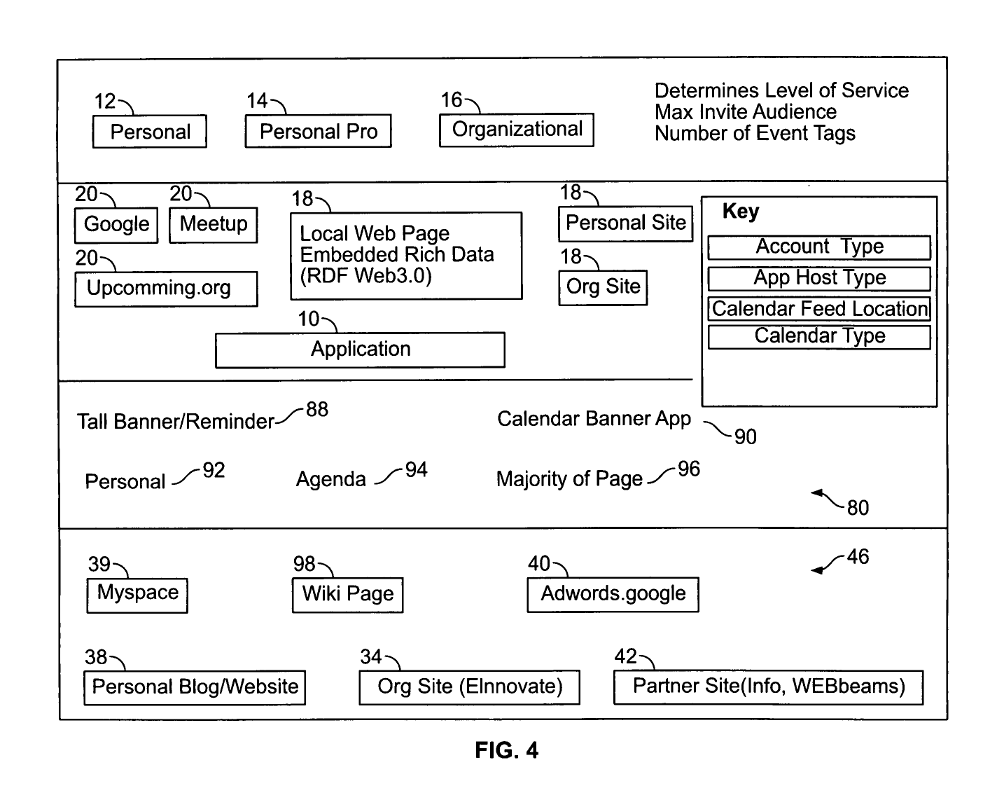

In addition to the event-specific revenue generation model discussed above, the calendar display application 80 may also generate revenue by encouraging users to upgrade their account type. Referring also to FIGS. 4-7, different types of accounts may be limited with respect to the resources from which they are able to draw information for their calendars, the types of calendar display applications 80 they are permitted to display on the Internet, and the locations on the Internet where they are permitted to display their calendar display applications 80.

User Accounts

FIG. 4 illustrates three account types, personal 12, personal pro 14, and organization 16 across the top of the Figure. Below the account types are sources of external user information 18, and external third party information 20, and immediately below those is application 10. Below the information sources is a section including examples of different types of calendar display applications 80. The different types of calendar display applications include a tall banner/reminder 88, a calendar banner application 90 (similar to that illustrated in FIG. 3), a personal calendar 92 for an individual web page, an agenda-style calendar 94 which may only display information for a single event, or calendar application which occupies the majority of a web page 96. Finally, below the calendar display applications are locations on the Internet 46 where the calendars might be displayed, including the organization website 34, personal blog or website 38, myspace 39, google sites 40, partner sites 42, and wiki-type websites 98.

An exemplary personal account 12 may be extremely limited regarding the features they are permitted to use, due at least in part to the fact that personal accounts 12 are either free or available for a minimal fee. For example, a personal account 12 may only be able to access certain sources of external third-party information 20, such as google, and may only be able to access the user's personal site and local web page (e.g. their own application page) for external user information 18. Similarly, the personal account 12 may only have access to the tall banner/reminder calendar 88, and the personal 92 and agenda type calendars 94. Finally, the personal account 12 may only be able to display or publish event information on their own pages, such as the user's personal myspace page 39, or the user's personal blog or website 38.

Because the personal pro account 14 requires payment of an additional fee, the holder of a personal pro account 14 will generally have access to additional features and functions relative to the holder of a personal account 12. In addition to the features available to the personal account 12, the personal pro account 14 may also have access to more sophisticated sources of external third-party information, such as meetup or Upcoming.org. Similarly, personal pro accounts may have access to each type of calendar display application 80, and may display or publish event information on a greater selection of locations on the Internet.

Similarly, because the organizational account is the highest-level account (in the illustrated examples, additional account structures are also possible), substantially all features and functionality are generally available to the holder of an organizational account 16. As discussed above, the organizational account 16 may include sub-users that are linked to the organizational account. In this regard, changes to an event or interaction with an event by an organizational account “master user” may result in event information being published or displayed on the calendars of each of the sub-users or on the calendars of selected groups of sub-users.

Zoomable Calendar Interface

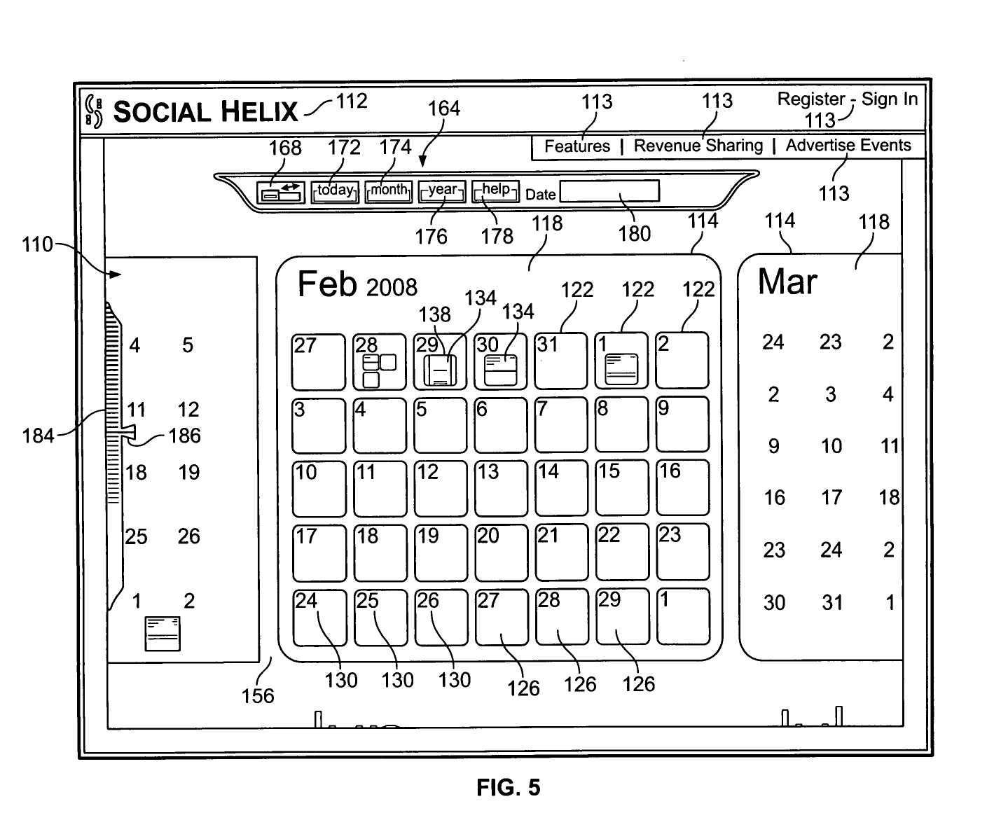

In addition to, in cooperation with, or in place of the calendar display application 80, application 10 may be associated with user interface 110 illustrated in FIGS. 5-9. In the illustrated embodiment, the interface 110 is displayed as part of an Internet webpage 112. The webpage 112 includes its own hyperlinks 113 and other content which may or may not be related to information provided or displayed by the interface 110. As illustrated, the interface 110 occupies a majority of the webpage 112, however as discussed further below, the interface 110 may also occupy only a small portion of the webpage or display area, and may be resizable by a user to occupy more or less of the display area as desired.

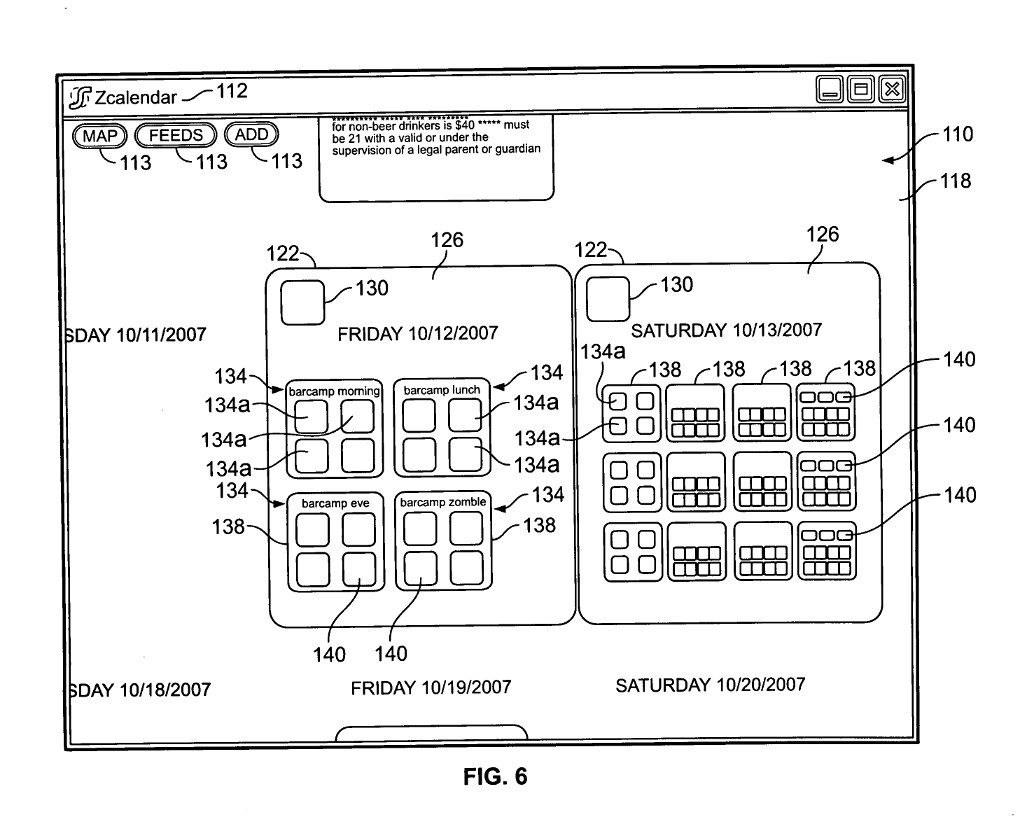

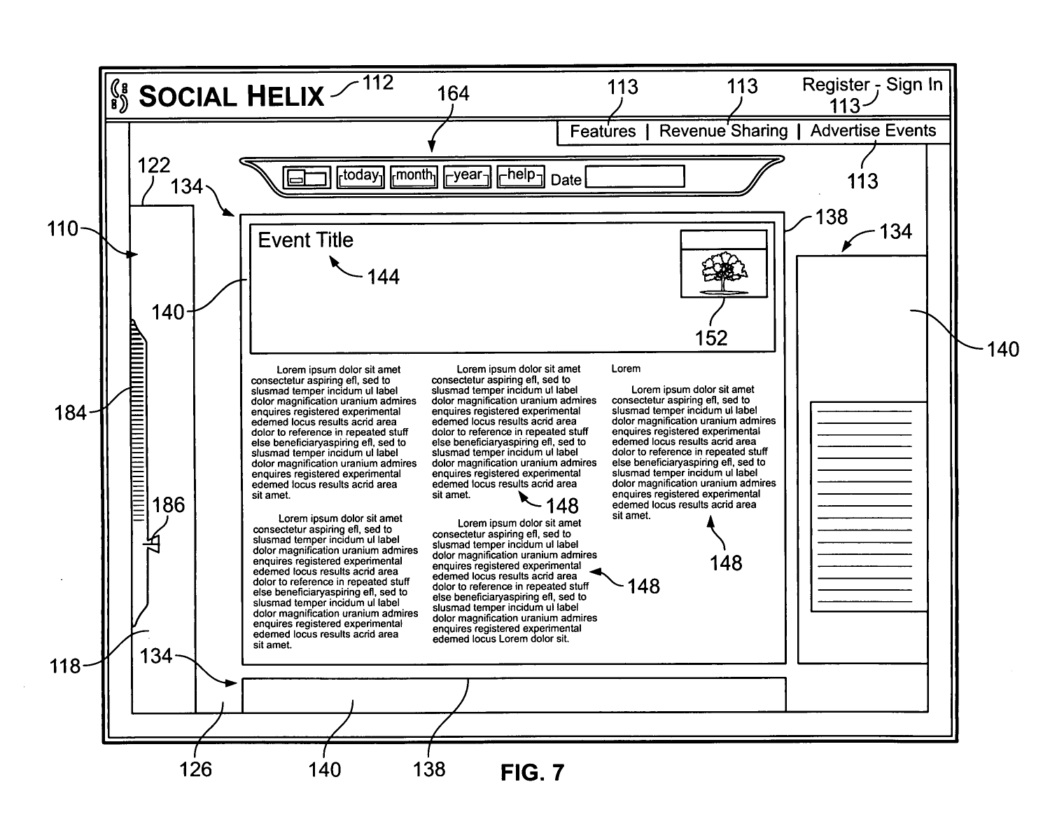

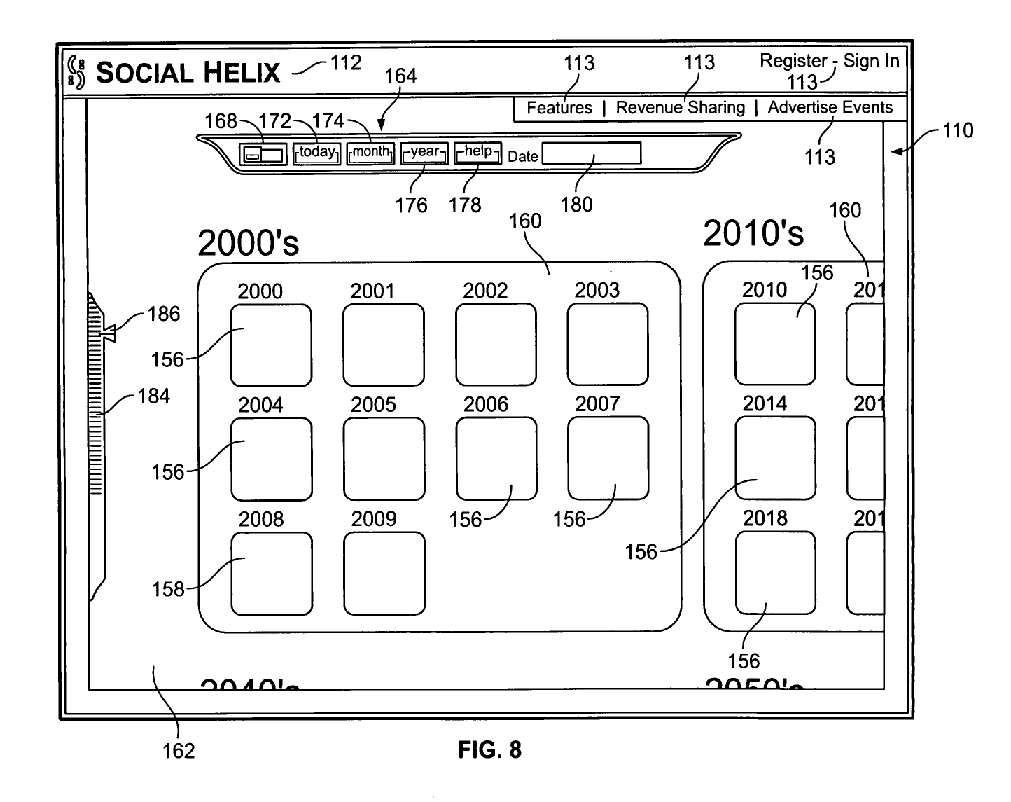

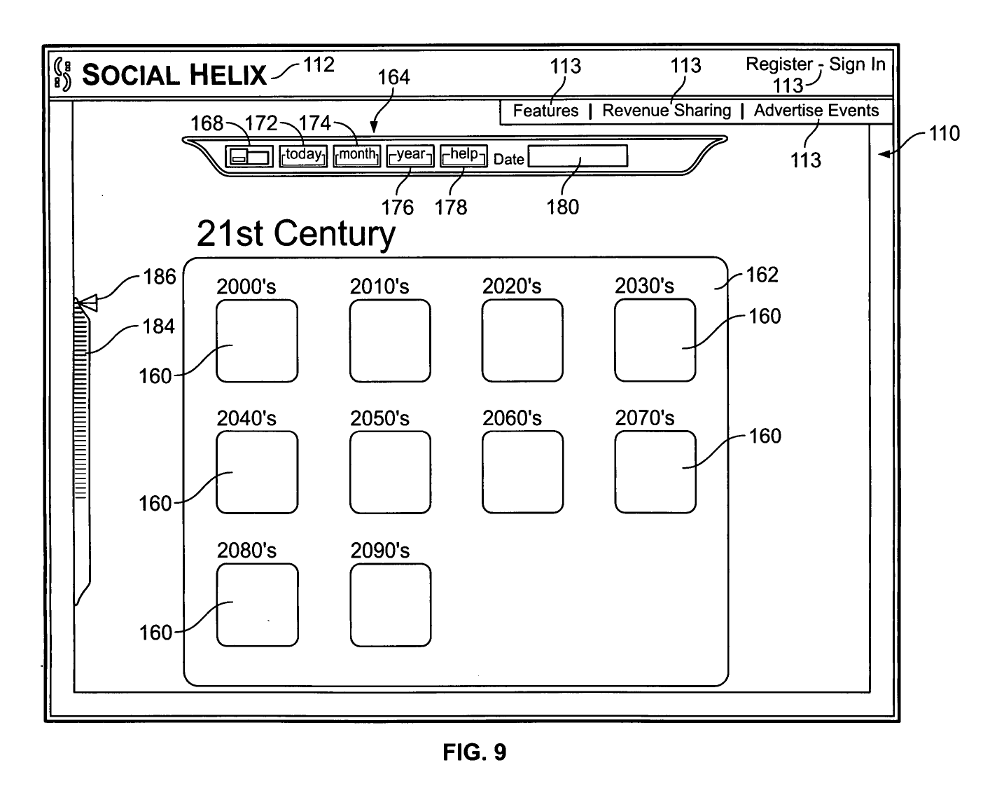

With reference to FIGS. 5-9 the display interface 110 displays a calendar that is substantially infinitely “zoomable” between a view of, for example, the entire 21^{st} century (FIG. 9), an individual month (FIG. 5), and die details of an individual event within a day (FIG. 7), and beyond. Zooming is controlled by a user in one of the manners described in detail below. As the calendar is zoomed in, for example from a “month view” (FIG. 5) toward a “day view,” font and image rendering software manage the display of text and images so that additional detail becomes visible. When the calendar is zoomed out, the font and image rendering software manage the display so that less detail is visible. As shown in the “century view” of FIG. 9, entire decades appear as a single box, however as the user zooms in to the “decade view” of FIG. 8, numbers and boxes representing individual years appear within the boxes representing the decades. Additional detail in the form of day dates and event listings is also revealed as the user zooms into views of individual years, individual months (FIG. 5), and individual days or portions of days (FIGS. 6 and 7).

As illustrated in the month view of FIG. 5, a single month (e.g. February, as illustrated) occupies the majority of the display space. Each month has associated therewith a box or month border 114 that defines the boundaries of an area of month space 118. Within the month space 118, additional boxes define day borders 122 that define the boundaries of an area of day space 126. The days are numbered at 130, and in many instances the final days of the previous month and the first days of the following month are displayed within the month space 118. The numbering 130 of those days not within the specific month may be of a different color, shading, or intensity relative to the numbering of the actual days of that month.

Referring also to FIG. 6, event listings 134 occupy the day space 126. The quantity, size, and type of event listings 134 on any given day will vary depending upon a number of factors that are discussed further below. Like months and days, event listings 134 include an event border 138 that defines the boundaries of an event space 140. As shown in FIG. 6, events listings 134 may include within them additional event listings 134a. In this regard, the interface 110 allows events to be “nested” within one another. For example, in FIG. 6 the event listing 134 for “barcamp morning,” which itself is an event having a time, date, location, etc., includes within it six additional event listings 134a. These additional event listings 134a are events within the event “barcamp morning,” such as specific presentations or lectures, each of which takes place within the “barcamp morning” event 134. By displaying “nested” events in this manner, rather than in a conventional temporal list, the organization of events in the calendar application can more closely reflect the way events tend to be organized in real life.

FIG. 7 illustrates an exemplary event listing 134 including primary information 144, which may include information like the time, date, and location of the event, and secondary information 148, which may include, among numerous other things, a more detailed description of the event, information about the event promoter, details on how to register for the event, hotlinks to external websites related to the event, and the like. With the calendar zoomed to the position illustrated in FIG. 7, the primary information 144 is easily legible, while the secondary information 148 is less so. To read the secondary information 148 the user simply zooms in on the secondary information 148, using any of the techniques discussed below, until the secondary information is fully legible. In many instances, the primary information 144 may be readable from a relatively distant zoom position (e.g. the month view of FIG. 5), which allows a user to scan the primary information 144 of several event listings 134 to find events in which he or she is interested. The user can then zoom in to view the secondary information 148 of only those event listings 134 that are of interest.

The event listing 134 of FIG. 7 also includes an event image 152. While the event image 152 appears relatively small in FIG. 7, the event image 152 is actually a high-resolution image or group of images that may include several megapixels of image detail. Users can zoom in to view the event image in the same way as users zoom in to view individual days and individual events. Furthermore, the calendar is substantially infinitely zoomable. In this regard, the event image 152 may include additional information or event listings that are “nested” within the event image 152 in a manner similar to that described above with the event listings 134 and 134a. By allowing for substantially infinite amounts of zooming, the calendar application has a substantially infinite amount of “event space” such that extremely large quantities of event information are accessible from a single calendar.

As discussed above, users can zoom the calendar in and out between a view of the entire 21^{st} century (or, in other embodiments, all of recorded time) to a substantially infinite number of nested event listings, images, etc. Zooming can be controlled in a number of different ways, generally using the input device. By way of example only, for a mouse device, clicking within the month space 118 of a month (e.g. February) will “snap zoom” the display to the month view (FIG. 5) for that month. In this regard, the term “snap zoom” means that the calendar application automatically zooms to a predetermined zoom level in which a certain portion of the calendar occupies a majority of the display. While in the month view, clicking within the month space 118 of an adjacent month will “slide” the display (e.g. to the left or the right) to display the month view of the prior or subsequent month. Clicking within the day space 126 of a given day will snap-zoom the calendar in to a day view display, in which a single day occupies the majority of the display. Once in the day view, clicking within the month space 118 surrounding the day space 126 (see FIG. 6) will snap zoom the calendar back out to the corresponding month view.

Similar snap zoom functionality is associated with the event listings 134, 134a. With reference to FIG. 6, clicking on one of the event listings 134 will snap zoom the calendar such that the event listing 134 occupies a majority of the display area. Clicking on one of the additional or nested event listings 134a, or on the event image 152 (FIG. 7) will snap zoom the display such that the additional event listing 134a or event image 152 occupies a majority of the display area. Clicking within the visible day space 126 or the month space 118 from any display configuration will automatically snap zoom the display back out to the corresponding day or month view. With reference to FIGS. 8 and 9, year space 156 associated with each year, decade space 160 associated with each decade, and century space 162 associated with each century, can similarly be clicked to snap zoom the calendar between years, decades, and centuries.

As shown in FIGS. 5 and 7-9, the display interface 110 includes a navigation panel 164 that extends along an upper edge of the interface 110. It should be appreciated that the navigation panel 164 could also be located along one of the side edges or the bottom edge of the interface 110. The navigation panel 164 includes a plurality of buttons intended to help the user navigate through the calendar. Specifically, the navigation panel 164 includes a full screen button 168 that, when clicked, expands the display interface 110 to occupy all available space on the screen of the display device. Clicking the full screen button 168 a second time, or pressing a specific key or button (e.g. the escape key), returns the display interface 110 to its original size. The navigation panel 164 also includes a today button 172, a month button 174, and a year button 176. When clicked, the today, month, and year buttons 172, 174, 176 snap zoom the calendar to the day view for the current day, the month view for the current month, and the year view for the current year, respectively. The navigation panel 164 also includes a help button 178 that, when clicked, opens a help window (not shown) that provides instructions and other information relating to the use and navigation of the calendar application. The navigation panel 164 also includes a date box 180. Users can position the cursor inside the date box 180 and enter a specific date. Upon entry of the specific date (e.g. by pressing the enter key), the display interface 110 snap zooms to the date entered by the user.

Although described above with respect to the well understood “clicking” selection method of a mouse device, the buttons of the navigation panel 164 and the snap zoom functionality can be configured to respond to a number of different types of inputs, depending upon, among other things, the specific type of input device. For example, if the input device is a touch pad or touch screen, a single or double finger tap (e.g. within the day space 126) may achieve the same result as the above-described mouse button click. In other embodiments, positioning a cursor or pointer using the mouse device and then pressing a preselected key or button on a keyboard may also initiate the snap zoom function. In still other embodiments, the input device may include an accelerometer, IR sensors, or similar attitude- or motion-sensing devices capable of detecting rotation or other movement of the device. The calendar may therefore be configured to respond to tilting or other movements of the device to pan, zoom, or snap to new locations on the calendar. In still other embodiments, video cameras or other optical sensors may be used to recognize hand gestures or other user movements for manipulation of the calendar interface. In this regard, as used herein the term “clicking” is intended to encompass these and other input device manipulations that function to, among other things, select, activate, or initiate an associated operation.

The display interface 110 is also responsive to a number of other user inputs that operate to zoom the calendar. For example, as shown in FIGS. 5 and 7-9, the display interface 110 includes a slide bar 184 along the left edge of the interface 110. The slide bar 184 includes an indicator 186 that is movable along the slide bar 184 using the input device to zoom the calendar in and out. For example, a user can click and hold the cursor over the indicator 186 and move the input device up and down to slide the indicator along the slide bar 184. As the indicator 186 moves, the calendar zooms in and out. In the illustrated embodiment, moving the indicator 186 upwardly along the slide bar 184 zooms the calendar out, while moving the indicator 186 downwardly zooms the calendar in. In this regard, FIG. 9 illustrated the indicator 186 at the top of the slide bar 184 while the calendar is zoomed out substantially as far as it will go, and displays the 21^{st} century. As shown in FIGS. 5, 7, and 8, the calendar zooms in as the indicator 186 moves progressively lower along the slide bar 184.

Another technique for zooming the calendar utilizes a scroll wheel, which is present in certain known mouse devices. Manipulating the scroll wheel, generally using the first or middle finger, to rotate the scroll wheel forwardly zooms the calendar in, while rotating the scroll wheel rearwardly zooms the calendar out. When using the scroll wheel, the calendar zooms in and out and centers the view based upon the position of the mouse cursor on the display screen. Some touch pads include a slide portion that is usually associated with one edge of the touch pad. In many computer applications, sliding the finger along the slide portion can be used to scroll the viewing window up and down relative to the computer screen. In some embodiments, the display interface 110 is configured to respond to finger movements along the slide portion by zooming the calendar in and out.

Yet another technique for zooming the calendar includes pressing and holding a specific key on a computer keyboard (e.g. the shift key) and manipulating the input device in a manner that would ordinarily be associated with up or down, or left or right movements of the cursor. Holding down the specific key alters the functionality of the input device so that movements that would ordinarily move the cursor around on the screen instead operate to zoom the calendar in and out.

Certain touch screen and touch pad input devices are capable of recognizing multiple finger touches. One example of such a touch screen is the touch screen on the iPhone device, available from Apple, Inc. of Cupertino, Calif. When installed on an iPhone or other device having a multi-touch input device, the calendar may be zoomed by touching the screen with two fingers and spreading the two fingers apart to zoom out, and then moving the two fingers back together again to zoom in. It is noteworthy that because of its ability to zoom in on a substantially unlimited number of nested event listings 34, the calendar application is particularly well suited for use on devices like the iPhone which have relatively small display sizes.

Yet another technique for zooming the calendar that is applicable to most, if not all input devices involves what is often referred to as “gesturing.” In this regard, the display interface 110 may be configured to recognize certain geometrically patterned movements of the input device. By way of example only, one form of gesturing involves manipulating the input device in small clockwise circles to zoom the calendar in, and manipulating the input device in small counter-clockwise circles to zoom the calendar out. This zooming technique may be particularly useful for users who do not have a scroll wheel, slide portion, or multi-touch capable input device.

Revenue Generation and Sharing

The display interface 110 may be combined with a revenue model that allows calendar owners to share in advertising and sales revenues generated by event listings on their calendars. The revenue model generally includes at least three, and in many instances four parties to a transaction. The first party is the calendar manager, this party has the greatest level of control over who uses the calendar, how the calendar can be used, and how the calendar can be customized.

The second party is the calendar publisher. The calendar publisher acquires the calendar application from the calendar manager and installs the calendar application on stand-alone computers or publishes the application a web page or as a portion of a web page. The calendar publisher creates, adds, removes, and modifies events on their calendar application. The calendar publisher may also sell space (e.g. advertising space) either within or surrounding their calendar application to advertisers or event promoters. In most cases, revenue generated from the sale of space within the calendar application is shared between the calendar publisher and the calendar manager. Calendar publishers may also pay the calendar manager a fixed sum on a “cost per thousand” or CPM basis such as, for example, 50 cents per 1000 calendar loads to the calendar manager. In some cases the fixed sum may only be payable once the calendar application has been loaded a certain number of times within a given time period such as, for example, 50,000 loads in one month. Calendar publishers may also set a calendar up as a “subscription only” calendar that requires viewers to pay to interact with the calendar. Subscription revenues would similarly be shared between the calendar publisher and the calendar manager. In many cases, the amount of control a calendar publisher has over the look and function of the calendar may depend upon the type of user account (described above) associated with the calendar publisher.

The third party is the advertiser. The advertiser may coordinate with either the calendar manager or the calendar publisher to buy advertising space within or surrounding the calendar application. If coordinating with the calendar manager, the advertiser may provide a profile or list of characteristics of the types of calendar applications on which the advertiser wants its ads to appear. For example, an advertiser may want to advertise or promote a product or service to an audience made up of individuals who support local music venues. The calendar manager would therefore “push” the advertiser's ads to calendar publishers having calendar applications with a large number of events taking place at local music venues, as that calendar is most likely to be viewed by the advertiser's target audience. This targeted advertising is made possible by the application 10, which allows the calendar manager to compile, sort, and search every event on every calendar application in the network. Advertisers may have an option of paying a fixed sum to run advertising for a fixed amount of time on a fixed number of calendars and/or may pay for advertisements on a “cost per interaction” or “CPI” basis, which is discussed further below.

The final party is the user. The user is an individual who views the calendar application, in many instances by way of a web browser while connected to the Internet. It should be noted that calendar publishers may also be, and often are calendar users. A first costing event occurs when the calendar user opens a web page containing the calendar application. This loads the calendar on the user's browser, which counts against CPM revenue numbers discusses above. As the user navigates the calendar application of a calendar publisher by way of the user interface discussed above, the user zooms in and out of months and days, and generally moves the calendar around to view, generally from “afar,” the events that may be going on during a given time frame. If the user clicks on a specific event listing, or zooms into an event listing in any manner such that the event listing takes up a substantial majority of the screen (e.g., the event view of FIG. 7, described above), the user is deemed to have “interacted” with the ad. This interaction is recorded by the calendar application and communicated to the calendar manager, who then charges the advertiser a fixed sum such as, for example, 10 cents, for every user interaction (“CPI”) with an add. Various other forms of user interaction may also be possible and may also give rise to suitable charges for the advertiser, such as, for example, the user requesting a text message or email reminder of an event, the user adding an event to his/her calendar, a user making an event visible to his/her social or event network, and the like. Revenue generated through user interactions may also be shared between the calendar manager and the calendar publisher.

It should be noted that where event listings, which may in fact be paid advertisements, may also include “nested” event listings (discussed above) which may also be paid advertisements. If the user “interacts” with a nested advertisement that interaction also triggers an interaction charge that is shared between at least the calendar manager and the calendar publisher; however in some cases, the owner of the event listing within which the nested advertisement appears may also share in some portion of the revenue. This arrangement allows for event listings to reflect real-world arrangements in which sponsors sponsor events. The event listing is a reflection of the event, and includes a nested advertisement for the event sponsor. As such, the sponsor may help offset some or all of the advertising cost generated through user interactions. Finally, event listings may also include click-through links that will direct the user away from the current web page to the web page of the advertiser who pays for the link. These click throughs may be charged in the known cost per click or “CPC” fashion at a rate that is generally higher than the CPM rate and the CPI rate, such as, for example, 2 dollars per click.

Although particular embodiments have been shown and described, other alternative embodiments will be apparent to those skilled in the art and are within the intended scope of the present invention.

1. A method of managing event information, the method comprising:
receiving event information for a plurality of events from a plurality of data sources;
creating an event index including an event database based on the event information;
hosting at least one type of calendar display application on a plurality of websites
automatically distributing selected portions of the event information for display by the calendar display application of selected ones of the plurality of websites;
collecting at least one of additional and alternative event information via the calendar display applications;
updating the event database in response to collecting the at least one of additional and alternative event information via the calendar display applications; and
automatically distributing the at least one of additional and alternative event information for display by the calendar display application of the selected ones of the plurality of websites.

2. The method of claim 1, wherein receiving event information includes receiving information from a user via a user interface.

3. The method of claim 2, wherein the user interface includes the at least one type of calendar display application.

4. The method of claim 1, wherein receiving event information includes automatically extracting information from the plurality of data sources.

5. The method of claim 4, wherein the plurality of data sources includes a plurality of Internet websites.

6. The method of claim 1, further comprising creating an event profile including at least some of the event information, and wherein automatically distributing selected portions of the event information for display by the calendar display application of selected ones of the plurality of websites includes automatically distributing the event profile.

7. The method of claim 6, further comprising monitoring for user interaction with the event profile, and distributing further portions of the event information in response to user interaction with the event profile.

8. A graphical calendar interface for display by a display system having a field of view, the calendar interface operating in response to inputs provided by an input device, the calendar interface comprising:
a plurality of month boundaries, each month boundary defining a month space corresponding to a month of a year;
a plurality of day boundaries positioned within each of the plurality of month boundaries, each day boundary defining a day space corresponding to a day of a month; and
an event boundary positioned within the day space of the day of the month corresponding to a date of an event, the event boundary defining an event space,
wherein the calendar interface is zoomable in response to inputs provided by the input device to a first plurality of views including and between a month view wherein the month space of a selected month occupies a substantial majority of the field of view, and a day view wherein the day space of a selected day of the month occupies a substantial majority of the field of view, and
wherein the calendar interface is further zoomable in response to inputs provided by the input device to a second plurality of views including and between the day view and an event view wherein the event space of a selected event occupies a substantial majority of the field of view.

9. The calendar interface of claim 8, wherein the interface automatically zooms to the month view in response to an input from the input device that is located within the month space, wherein the interface automatically zooms to the day view in response to an input from the input device that is located within the day space, and wherein the interface automatically zooms to the event view in response to an input from the input device that is located within the event space.

10. The calendar interface of claim 8, wherein the interface zooms to the first and second plurality of views in response to movement of a scroll-wheel device on the input device.

11. The calendar interface of claim 8, wherein the interface zooms from the month view toward the event view in response to clockwise and substantially circular manipulation of the input device, and wherein the interface zooms from the event view toward the month view in response to counterclockwise and substantially circular manipulation of the input device.

12. The calendar interface of claim 8, wherein the event space includes primary and secondary event information, and wherein the interface is zoomable to a third plurality of views wherein at least some of the primary and secondary information occupies a substantial majority of the field of view.

13. The calendar interface of claim 12, wherein at least a portion of the primary event information is visible when the interface is in the month view, and wherein the secondary information is not visible when the interface is in the month view.

14. The calendar interface of claim 8, wherein when the interface is in the day view, a portion of an adjacent day space is within the field of view, and wherein the adjacent day space is centered within the field of view in response to an input from the input device located within the adjacent day space.

15. The calendar interface of claim 8, further comprising a plurality of year boundaries, each year boundary defining a year space that surrounds a group of the plurality of month boundaries, and a century boundary defining a century space and surrounding the plurality of year boundaries, and wherein the interface automatically zooms to a year view in response to an input from the input device that is located within the year space, and wherein the interface automatically zooms to a century view in response to an input from the input device that is located within the century space.

16. A method for monitoring user interaction with a website and charging advertisers for the user interaction, the method comprising:
providing a database containing data;
providing a user interface for display of at least some of the data within a field of view on a display device, the field of view divided into a plurality of locations, the user interface zoomable between a plurality of predetermined views including at least a first view in which a first number of locations are within the field of view, and a second view in which a second number of locations smaller than the first number of locations are within the field of view;
defining an advertiser space within one of the locations, the advertiser space including the at least some of the data;
monitoring user interaction with the user interface to determine when the interface is zoomed to the first and second views;
determining whether the advertiser space is within the field of view each time the interface is zoomed to the first and second views;
recording a first advertiser charge in the database each time the advertiser space is within the field of view when the interface is zoomed to the first view; and
recording a second advertiser charge in the database each time the advertiser space is within the field of view when the interface is zoomed to the second view.

17. The method of claim 16, further comprising monitoring user interaction with the user interface to determine when the user provides an input located within the advertiser space, and recording a third advertiser charge in the database in response to determining that the user has provided an input located within the advertiser space.

18. The method of claim 16, wherein the data includes event data, the user interface includes a calendar interface, the plurality of locations include day spaces, the advertiser space includes event listings, the first view includes a day view, and the second view includes an event view, and wherein recording the first advertiser charge includes recording the first advertiser charge when the advertiser space is within the day space of a day that occupies the field of view when the interface is zoomed to the day view, and recording the second advertiser charge includes recording the second advertising charge when the advertiser space occupies a substantial majority of the field of view when the interface is zoomed to the event view, the second advertising charge being greater than the first advertising charge.
